(19) United States
(12) Patent Application Publication
(10) Pub. No.: US 2013/0097228 A1
(43) Pub. Date: Apr. 18, 2013

(54) NETWORK STORAGE SYSTEM, DATA MANIPULATION METHOD IN NETWORK STORAGE SYSTEM, STORAGE DEVICE AND COMPUTER PROGRAM PRODUCT FOR CONTROLLING CLIENT DEVICE

(71) Applicant: Buffalo Inc., Nagoya-shi (JP)

(72) Inventor: Taichi EJIRI, Aichi (JP)

(73) Assignee: Buffalo Inc., Nagoya-shi (JP)

(21) Appl. No.: 13/653,853

(22) Filed: Oct. 17, 2012

(30) Foreign Application Priority Data
Oct. 18, 2011 (JP) 2011-228475

(51) Int. Cl. G06F 15/16

(52) U.S. Cl. 709/203

(57) ABSTRACT

In a network storage system including a network-attachable storage device, a notification server, and a client device are interconnected via a network the storage device comprises: an address acquirer that sends an inquiry about an address of the client device to the notification server and acquires the address; an operation request acquirer that sends an inquiry about an operation request for the storage device to the client device having the acquired address and acquires the operation request; and a request transmitter that sends at least one of a request based on the acquired operation request and data processed in the storage device based on the acquired operation request, to the client device.

### CROSS-REFERENCE TO RELATED APPLICATIONS

This application claims priority to Japanese Patent Application No. 2011-228475 filed on Oct. 18, 2011, which is hereby incorporated by reference in its entirety and for all purposes.

### BACKGROUND

1. Field of the Disclosure

The present disclosure relates to technique that has access to a storage device located in a Local Area Network (LAN) via the Internet.

2. Description of the Related Art

A wide variety of functions similar to those of the personal computers are provided and used in portable devices such as smartphones. Various data, such as voice data, image data and application data are stored in the smartphone. The smartphone is desired to have the higher memory capacity for this purpose, but memory capacity of smartphone is limited for the purpose of size reduction.

The proposed technique connects a network attached storage (NAS) including an external mass storage device to a home or office LAN and allows access from the smartphone to the network attached storage via the Internet. For example, the “Web access” function and the “CloudStor” function are known as the technique to have access to the network attached storage located in the LAN via the Internet.

The “Web access” function uses the UPnP function of a router connected with the network attached storage to allow direct access between the smartphone and the network attached storage. In the router that does not have the UPnP function, however, the “Web access” function has the problem that requires the user's complicated operations to set port forwarding of the router. In the router that does not have the UPnP function and is incompatible to a change in setting of port forwarding, the “Web access” function additionally has the problem that does not allow connection between the smartphone and the network attached storage. The “CloudStor” function allows access between the smartphone and the network attached storage by providing a relay server on the Internet to relay data forwarding between the smartphone and the network attached storage. The “CloudStor” function, however, has the problem that increases in load of the relay server provided to relay data forwarding with an increase in number of smartphones and may lower the processing speed for data forwarding or may cause interruption of data forwarding service due to server down.

These problems are not limited to the network attached storages but are commonly found in network-attachable storage devices.

### SUMMARY

Network storage systems and data manipulation methods for a network storage system are discussed herein. The disclosure may be implemented according to numerous aspects: for example, a network storage system, a data manipulation method in a network storage system, a storage device, a client device connected with a storage device, or computer instructions to enable the functions of any of these methods and devices and a storage medium in which such a computer program is stored.

According to a first aspect, a network storage system can include a network-attachable storage device, a notification server and a client device connected via a network. The client device can be configured to send a request to the notification server to start communication with the storage device; receive, from the storage device, a second inquiry about an operation request of data for the storage device; and send the operation request of data for the storage device as a reply to the second inquiry. The notification server can be configured to receive, from the client device, the notification to start communication with the storage device; receive, from the storage device, a first inquiry about an address of the client device inquiry about an address of the client device; send, to the storage device, information representing an absence of the request to start communication as a reply to the first inquiry when there is no request to start communication received from the client device; and send, to the storage device, the address of the client device as the reply to the first inquiry when there is the request to start communication received from the client device. The storage device can be configured to send the second inquiry to the notification server, and acquire the address from the notification server as a reply to the first inquiry; send the first inquiry when the client address is acquired, and acquire the operation request from the client device as a reply to the second inquiry; and perform at least one of a reception or a transmission of data respectively from or to the client device, based on the acquired operation request.

According to another aspect, a data manipulation method in such a network storage system can include requesting, by the client device, the notification server to start communication with the storage device; inquiring, as a first inquiring by the storage device, about an address of the client device to the notification server; sending, by the notification server, information representing an absence of the request to start communication as a reply to the first inquiring when there is no request to start communication from the client device, and sending the address of the client device as the reply to the first inquiring when there is the request to start communication; acquiring, by the storage device, the sent address of the client device; inquiring, as a second inquiring by the storage device, about an operation request of data for the storage device to the client device having the acquired address; sending, by the client device, the operation request for the storage device as a reply to the second inquiring; acquiring, by the storage device, the sent operation request; and performing, by the storage device, at least one of transmission or reception of data respectively to or from the client device, based on the sent operation request acquired by the storage device.

Further, a non-transitory computer readable medium having instructions stored therein that when executed by a processor, can cause the processor to perform such a method.

According to another aspect, a storage device can include an address acquirer that sends a first inquiry about an address of a client device connected with the storage device via a network to a notification server connected with the storage device via the network, and acquires the address as a reply to the first inquiry. The storage device can include an operation request acquirer that sends a second inquiry about an operation request of data for the storage device to the client device having the acquired address, and acquires the operation request as a reply to the second inquiry. Additionally, the storage device can include a request transmitter that performs at least one of a reception or a transmission of data respectively from or to the client device, based on the acquired operation request.

The foregoing general description of the illustrative implementations and the following detailed description thereof are merely exemplary aspects of the teachings of this disclosure, and are not restrictive.

### BRIEF DESCRIPTION OF THE DRAWINGS

FIG. 1 schematically illustrates the configuration of a network storage system according to one embodiment of the disclosure;

FIG. 2 is a block diagram illustrating the structure of an NAS shown in FIG. 1;

FIG. 3 is a block diagram illustrating the structure of a notification server shown in FIG. 1;

FIG. 4 is a block diagram illustrating the structure of a client shown in FIG. 1;

FIG. 5 is a flowchart showing a procedure of server communication process on NAS;

FIG. 6 is a flowchart showing a procedure of client communication process on NAS;

FIG. 7 is a flowchart showing a procedure of notification process;

FIG. 8 is a flowchart showing a procedure of server communication process on client;

FIG. 9 is a flowchart showing a procedure of NAS communication process on client;

FIG. 10 illustrates a client standby sequence;

FIG. 11 illustrates a communication start/in-communication sequence;

FIG. 12 illustrates a communication end sequence; and

FIG. 13 illustrates a communication start/in-communication sequence according to a second embodiment.

### DESCRIPTION OF THE PREFERRED EMBODIMENTS

The following describes embodiments of the disclosure with reference to the accompanying drawings.

### A. First Embodiment

A-1. System Configuration and Outline

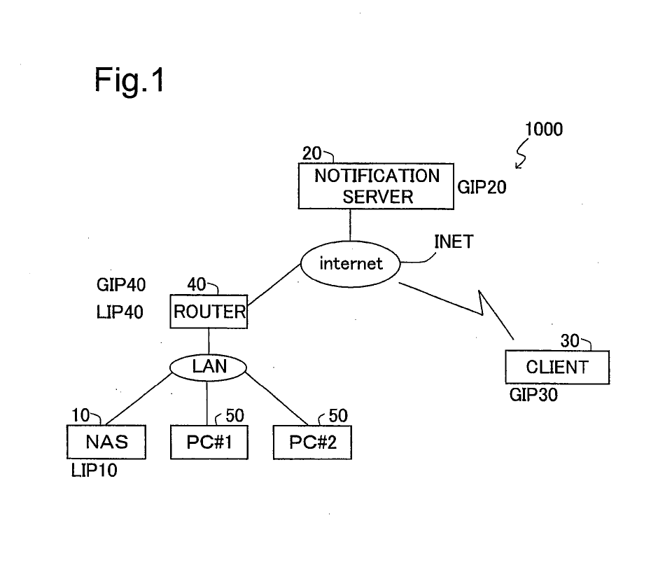

FIG. 1 schematically illustrates the configuration of a network storage system 1000 according to one embodiment of the disclosure. The network storage system 1000 includes a network attached storage (hereinafter referred to as “NAS”) 10, a notification server 20, a client 30 and a router 40. The NAS 10 is connected with the notification server 20 on the Internet INET via the router 40. The client 30 is connected to the Internet INET via an access point. The network storage system 1000 may further include personal computers (PC) 50. The network attached storage (NAS) herein corresponds to the “storage device” in the claims.

The NAS 10 is a network-attachable storage device and is capable of storing various data including voice data, image data and application data (hereinafter such data may be collectively referred to as “user data”). The NAS 10 is located in a LAN to serve as an internal node of the router 40 and has an assigned local IP address “LIP 10”. The notification server 20 works to notify the NAS 10 of the address of the client 30. The notification server 20 is located on the Internet INET to serve as an external node of the router 40 and has an assigned global IP address “GIP20”. The client 30 is a device having the functions to access the Internet INET and is a smartphone according to this embodiment. The client 30 is located on the Internet INET to serve as an external node of the router 40, when being connected to the Internet INET. When the client 30 is connected to the Internet INET, a global IP address “GIP30” is assigned to the client 30.

According to this embodiment, at least the following two control procedures (described later in detail) are performed to have access from the client 30 as the external node of the router 40 to the NAS 10 as the internal node of the router 40 without using the UPnP function of the router 40 or using a relay server provided to relay data forwarding:

(a) control of address notification by the notification server 20 at the start of communication; and

(b) control of information acquisition by polling from the NAS 10 to the other devices as external nodes of the router 40 (i.e., notification server 20 and client 30).

The polling herein corresponds to the “inquiry” in the claims.

A-2. Structure of NAS

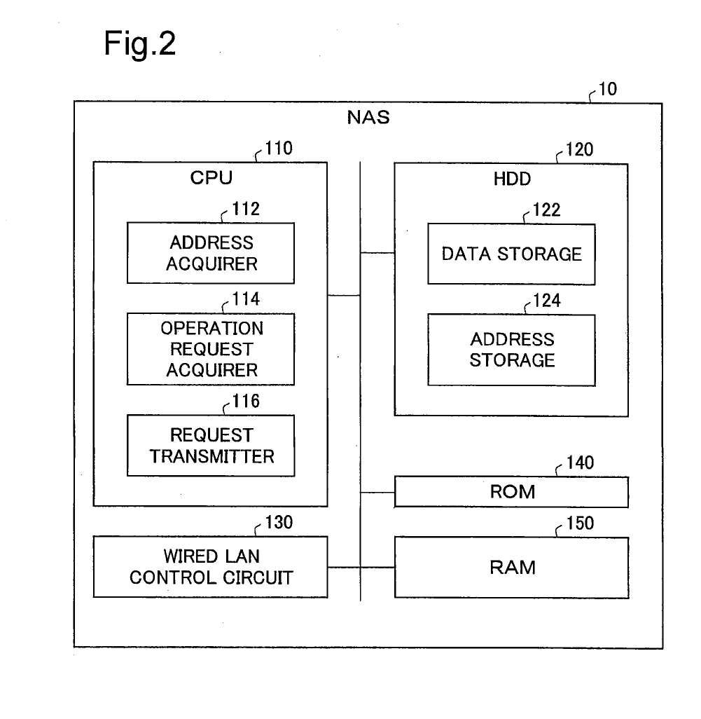

FIG. 2 is a block diagram illustrating the structure of the NAS 10 shown in FIG. 1. The NAS 10 includes a CPU 110, a hard disk drive (hereinafter referred to as “HDD”) 120, a wired LAN control circuit 130, a ROM 140 and a RAM 150, which are interconnected by a bus.

The CPU 110 loads and executes a computer program, which is stored in the HDD 120, on the RAM 150, so as to control the respective components of the NAS 10. As a result, the CPU 110 may work as an address acquirer 112, an operation request acquirer 114 and a request transmitter 116. The details of the respective functional parts will be described later. The HDD 120 is an external mass storage device and includes a data storage 122 and an address storage 124. The data storage 122 is a field provided for storing user data. The address storage 124 is a field provided for storing the IP address of the client 30, which corresponds to the address of the client device in the claims. The IP address of the client 30 is used in a client communication process on the NAS 10 as described later. The wired LAN control circuit 130 includes a connection interface for a LAN cable and is provided as a circuit to allow a network access by a wired LAN.

A-3. Structure of Notification Server

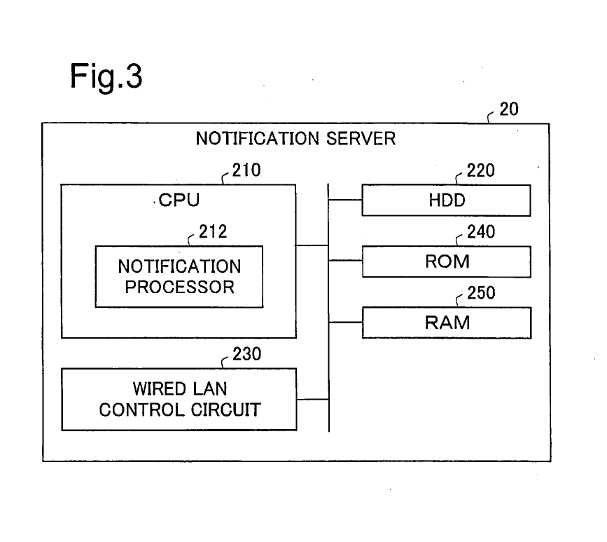

FIG. 3 is a block diagram illustrating the structure of the notification server 20 shown in FIG. 1. The notification server 20 includes a CPU 210, an HDD 220, a wired LAN control circuit 230, a ROM 240 and a RAM 250, which are interconnected by a bus.

The CPU 210 loads and executes a computer program, which is stored in the HDD 220, on the RAM 250, so as to control the respective components of the notification server 20. As a result, the CPU 210 may work as a notification processor 212. The details of the notification processor 212 will be described later. The HDD 220 is an external storage device. The wired LAN control circuit 230 includes a connection interface for a LAN cable and is provided as a circuit to allow a network access by a wired LAN.

A-4. Structure of Client

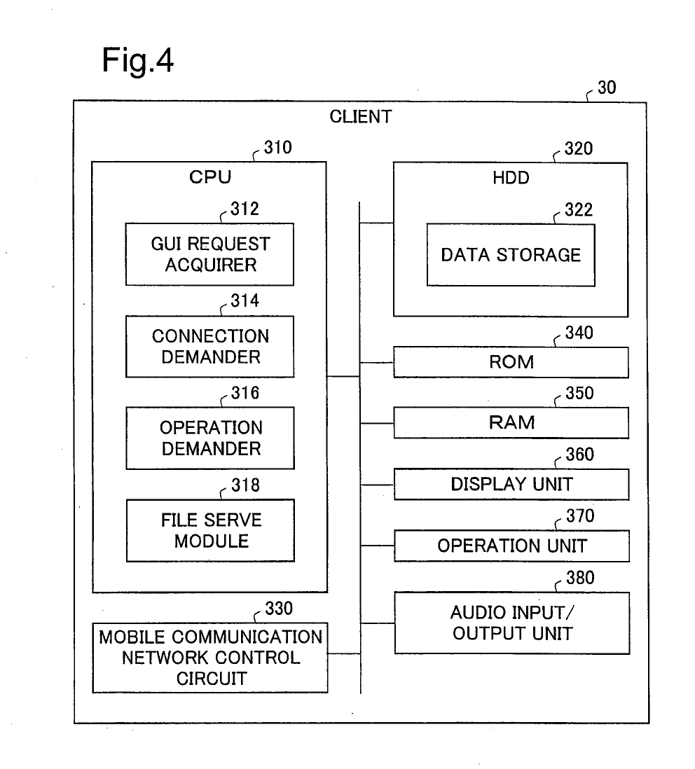

FIG. 4 is a block diagram illustrating the structure of the client 30 shown in FIG. 1. The client 30 includes a CPU 310, an HDD 320, a mobile communication network control circuit 330, a ROM 340, a RAM 350, a display unit 360, an operation unit 370 and an audio input/output unit 380.

The CPU 310 loads and executes a computer program, which is stored in the HDD 320, on the RAM 350, so as to control the respective components of the client 30. As a result, the CPU 310 may work as a GUI request acquirer 312, a connection demander 314, an operation demander 316 and a file server module 318. The details of the respective functional parts will be described later. The HDD 320 is an external storage device and includes a data storage 322. The data storage 322 is a field provided for storing user data. The mobile communication network control circuit 330 includes a modulator, an amplifier and an antenna and serves as, for example, a mobile communication station conforming to 3G/HSPA to make wireless communication with an access point of a mobile communication network. The display unit 360 includes a display and a display driver and gives visual outputs to the user, i.e., visual indications on the display. The operation unit 370 includes entry keys and an entry key driver and is provided to receive the user's entries. A touch panel may be employed as a device having both the functions of the display unit 360 and the operation unit 370. The audio input/output unit 380 includes a microphone and a speaker and enables the voice inputs and outputs from and to the user.

A-5. Processing by NAS

The following describes series of processing performed by the NAS 10.

A-5-1. Server Communication Process on NAS

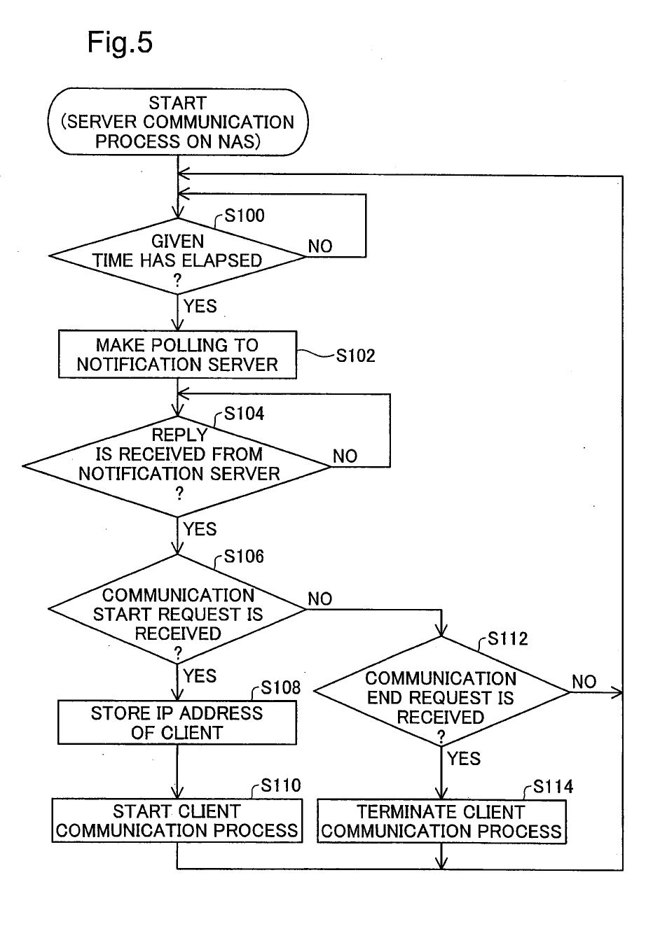

FIG. 5 is a flowchart showing a procedure of server communication process on NAS. The server communication process on NAS causes the NAS 10 to obtain an “instruction to start/terminate communication with the client 30” from the notification server 20 and is performed by the address acquirer 112 as the functional part of the CPU 110.

The address acquirer 112 of the NAS 10 determines whether a given time has elapsed since the start of this routine shown in the flowchart of FIG. 5 or since completion of the last processing of either step S110 or step S114 (step S100). The “given time” at step S100 intends a time interval of polling from the NAS 10 to the notification server 20 and may be set to any arbitrary value. When it is determined that the given time has not yet elapsed (step S100: NO), the address acquirer 112 repeats the processing of step S100 and waits until the given time has elapsed. When it is determined that the given time has elapsed (step S100: YES), on the other hand, the address acquirer 112 makes a polling to the notification server 20 (FIG. 1) (step S102). More specifically, the address acquirer 112 generates a polling packet including the global IP address of the notification server 20, which corresponds to the address of the notification server in the claims. The global IP address of the notification server 20 is registered in advance in the HDD 120 of the NAS 10. The polling packet may have any arbitrary format. The address acquirer 112 sends the generated polling packet to the notification server 20 via the router 40.

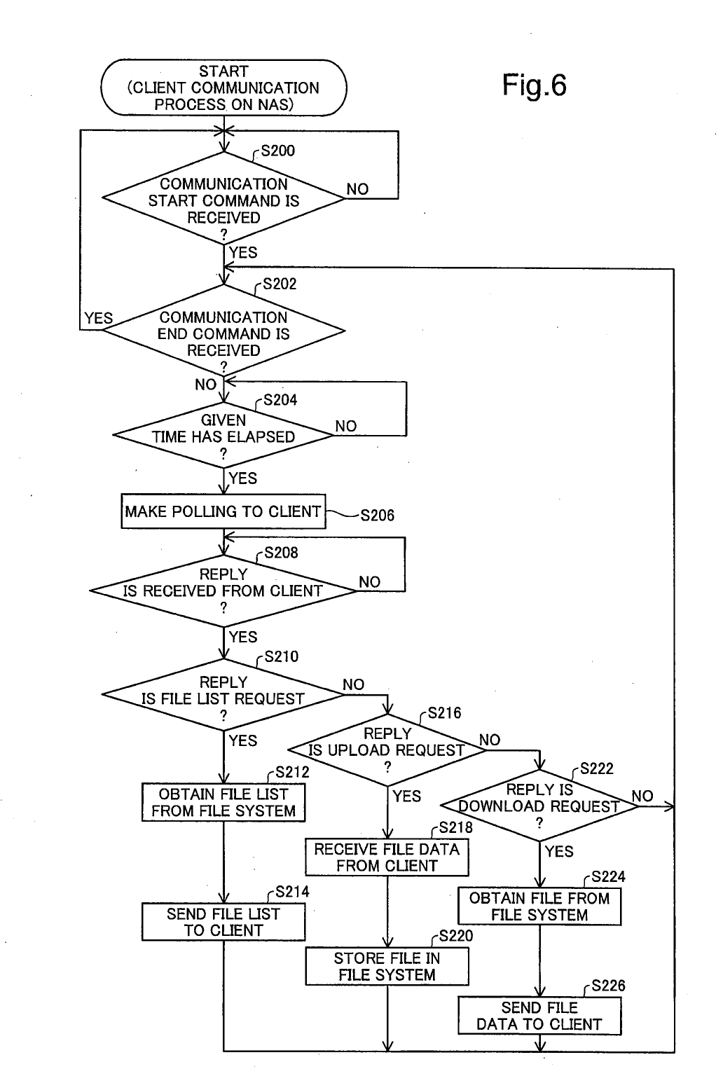

The address acquirer 112 then determines whether a reply to the polling at step S102 is received from the notification server 20 (step S104). When it is determined that no reply is received from the notification server 20 (step S104: NO), the address acquirer 112 repeats the processing of step S104 and waits until a reply is received from the notification server 20. When it is determined that the reply is received from the notification server 20 (step S104: YES), the address acquirer 112 subsequently determines whether the received reply is a communication start request (step S106). More specifically, when the reply packet received from the notification server 20 includes both a “request to start communication” and the “IP address of the client 30 (FIG. 1)”, the address acquirer 112 determines that a communication start request is received. When the reply packet received from the notification server 20 does not include at least one of the “request to start communication” and the “IP address of the client 30 (FIG. 1)”, on the other hand, the address acquirer 112 determines that no communication start request is received. When it is determined that the communication start request is received (step S106: YES), the address acquirer 112 stores the “IP address of the client 30” included in the reply packet into the address storage 124 in the HDD 120 (step S108). The address acquirer 112 subsequently sends a communication start command to the operation request acquirer 114 to start the client communication process (FIG. 6) (step S110). The address acquirer 112 then returns the processing flow to step S100.

When it is determined that no communication start request is received (step S106: NO), on the other hand, the address acquirer subsequently determines whether a communication end request is received (step S112). More specifically, when the reply packet received from the notification server 30 includes a “request to end communication”, the address acquirer 112 determines that a communication end request is received. When the reply packet received from the notification server 30 does not include the “request to end communication”, on the other hand, the address acquirer 112 determines that no communication end request is received. When it is determined that the communication end request is received (step S112: YES), the address acquirer 112 sends a communication end command to the operation request acquirer 114 to terminate the running client communication process (FIG. 6). The address acquirer 112 then returns the processing flow to step S100. When it is determined that no communication end request is received (step S112: NO), on the other hand, the address acquirer 112 immediately returns the processing flow to step S100.

A-5-2. Client Communication Process on NAS

FIG. 6 is a flowchart showing a procedure of client communication process on NAS. The client communication process on NAS causes the NAS 10 to transfer data to and from the client 30 and is performed by the operation request acquirer 114 and the request transmitter 116 as the functional parts of the CPU 110.

The operation request acquirer 114 of the NAS 10 determines whether the communication start command (FIG. 5: step S110) is received from the address acquirer 112 that performs the server communication process on NAS (step S200). When it is determined that no communication start command is received (step S200: NO), the operation request acquirer 114 repeats the processing of step S200. When it is determined that the communication start command is received (step S200: YES), on the other hand, the operation request acquirer 114 subsequently determines whether the communication end command (FIG. 5: step S114) is received from the address acquirer 112 that performs the server communication process on NAS (step S202). When it is determined that the communication end command is received (step S202: YES), the operation request acquirer 114 returns the processing flow to step S200. In this case, the client communication process routine (of and after step S204) is not performed any further.

When it is determined that no communication end command is received (step S202: NO), on the other hand, the operation request acquirer 114 determines whether a given time has elapsed since completion of the last processing of step S202 (step S204). The “given time” at step S204 intends a time interval of polling from the NAS 10 to the client 30 and may be set to any arbitrary value. When it is determined that the given time has not yet elapsed (step S204: NO), the operation request acquirer 114 repeats the processing of step S204 and waits until the given time has elapsed. When it is determined that the given time has elapsed (step S204: YES), on the other hand, the operation request acquirer 114 makes a polling to the client 30 (FIG. 1) (step S206). More specifically, the operation request acquirer 114 generates a polling packet including the global IP address of the client 30, which corresponds to the address of the client device in the claims. The global IP address of the client 30 is notified by the notification server 20 in the server communication process on NAS and is stored in the address storage 124 of the HDD 120 (FIG. 5: step S108). The polling packet may have any arbitrary format. The operation request acquirer 114 sends the generated polling packet to the client 30 via the router 40 (FIG. 1).

The operation request acquirer 114 subsequently determines whether a reply to the polling of step S206 is received from the client 30 (step S208). When it is determined that no reply is received from the client 30 (step S208: NO), the operation request acquirer 114 repeats the processing of step S208 and stands by for reception of the reply.

When it is determined that the reply is received from the client 30 (step S208: YES), the operation request acquirer 114 determines whether the received reply is a file list request (step S210). More specifically, when the reply packet received from the client 30 includes both a “request to obtain a file list” and a “location on the NAS 10” from which the file request is to be obtained, the operation request acquirer 114 determines that a file list request is received. When the reply packet received from the client 30 does not include at least one of the “request to obtain a file list” and the “location on the NAS 10” from which the file request is to be obtained, on the other hand, the operation request acquirer 114 determines that the reply received from the client 30 is not the file list request. The “location on the NAS 10” in the reply packet may be omitted by default setting. In this case, when the reply packet received from the client 30 does not include the “request to obtain a file list”, the operation request acquirer 114 determines that the reply received from the client 30 is not the file list request. When it is determined that the reply received from the client 30 is the file list request (step S210: YES), the request transmitter 116 accesses the data storage 122 and obtains a list of files and folders at a location identified by the “location on the NAS 10” included in the reply packet received from the client 30 (step S212). The request transmitter 116 then sends the data processed in the NAS 10, i.e., the list of files and folders obtained at step S212 to the client 30 (step S214).

When it is determined that the reply received from the client 30 is not the file list request (step S210: NO), on the other hand, the operation request acquirer 114 subsequently determines whether the received reply is an upload request (step S216). More specifically, when the reply packet received from the client 30 includes both a “request to upload” and a “location on the NAS 10” to which data is to be uploaded, the operation request acquirer 114 determines that an upload request is received. When the reply packet received from the client 30 does not include at least one of the “request to upload” and the “location on the NAS 10” to which data is to be uploaded, on the other hand, the operation request acquirer 114 determines that the reply received from the client 30 is not the upload request. The “location on the NAS 10” in the reply packet may be omitted by default setting. In this case, when the reply packet received from the client 30 does not include the “request to upload”, the operation request acquirer 114 determines that the reply received from the client 30 is not the upload request. When it is determined that the reply received from the client 30 is the upload request (step S216: YES), the request transmitter 116 sends a transmission request of a file to be uploaded to the client 30 (FIG. 1) based on the upload request and receives file data from the client 30 (step S218). The request transmitter 116 then accesses the data storage 122 and stores the received file at a location identified by the “location on the NAS 10” included in the reply packet received from the client 30 (step S220).

When it is determined that the reply received from the client 30 is not the upload request (step S216: NO), on the other hand, the operation request acquirer 114 subsequently determines whether the received replay is a download request (step S222). More specifically, when the reply packet received from the client 30 includes all a “request to download”, a “location on the NAS 10” from which data is to be downloaded and a “file (folder) identifier”, the operation request acquirer 114 determines that a download request is received. When the reply packet received from the client 30 does not include at least any one of the “request to download”, the “location on the NAS 10” from which data is to be downloaded and the “file (folder) identifier”, on the other hand, the operation request acquirer 114 determines that the reply received from the client 30 is not the download request. The “location on the NAS 10” in the reply packet may be omitted by default setting. In this case, when the reply packet received from the client 30 does not include at least one of the “request to download” and the “file (folder) identifier”, the operation request acquirer 114 determines that the reply received from the client 30 is not the download request. When it is determined that the reply received from the client 30 is the download request (step S222: YES), the request transmitter 116 obtains a file or a folder (step S224). More specifically, the request transmitter 116 accesses the data storage 122 and obtains a file or a folder identified by the “file (folder) identifier” from a location identified by the “location on the NAS 10” included in the reply packet received from the client 30 (step S224). The request transmitter 116 then sends the data processed in the NAS 10, i.e., the file or the folder obtained at step S224, to the client 30 (step S226).

When it is determined that the reply received from the client 30 is not the download request (step S222: NO), on the other hand, the request transmitter 116 returns the processing flow to step S202 to determine whether the communication end command is received. The processing flow is also returned to step S202 after completion of the processing at any one of steps S214, S220 and S226.

A-6. Processing by Notification Server

The following describes series of processing performed by the notification server 20.

A-6-1. Notification Process

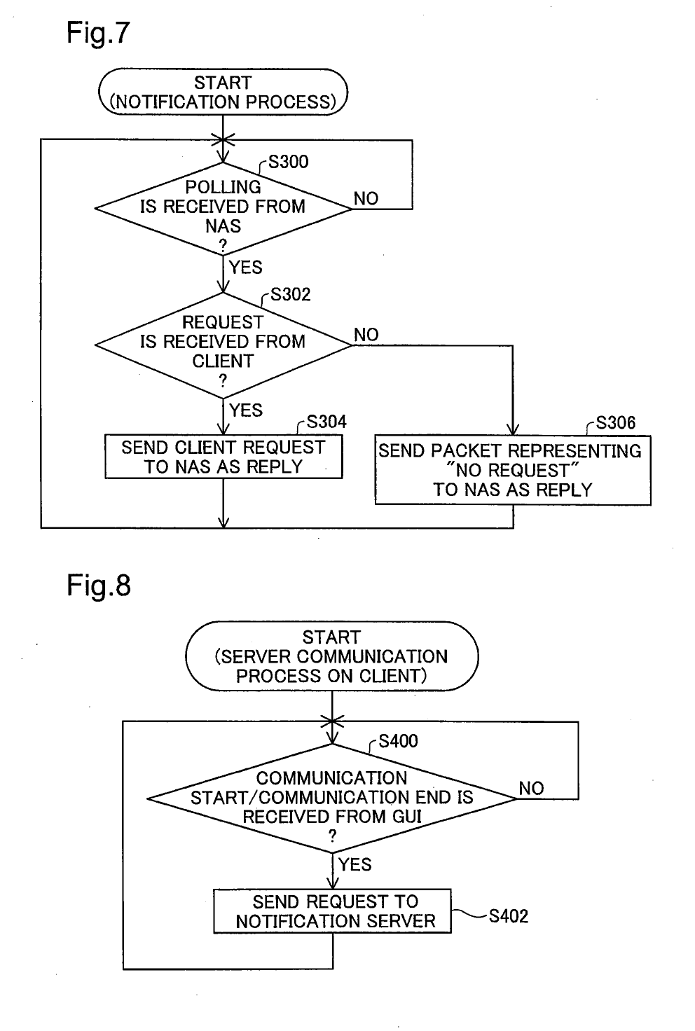

FIG. 7 is a flowchart showing a procedure of notification process. The notification process causes the notification server 20 to send the “instruction to start/terminate communication with the client 30” to the NAS 10 and is performed by the notification processor 212 as the functional part of the CPU 210.

The notification processor 212 of the notification server 20 determines whether a polling is received from the NAS 10 (FIG. 1) (step S300). When it is determined that no polling is received from the NAS 10 (step S300: NO), the notification processor 212 repeats the processing of step S300 and stands by for reception of a polling. When it is determined that the polling is received from the NAS 10 (step S300: YES), on the other hand, the notification processor 212 subsequently determines whether a request packet is received from the client 30 (FIG. 1) (step S302).

When it is determined that the request packet is received from the client 30 (step S302: YES), the notification processor 212 sends the received request packet as a reply to the polling from the NAS 10 (step S304). When the data field of the request packet received from the client 30 does not include the IP address of the client 30, the notification processor 212 may perform the following process at step S304. The notification processor 212 may generate a new packet by adding the source IP address (i.e., the IP address of the client 30) included in the header of the received request packet to the received request packet and send the generated new packet as a reply to the polling from the NAS 10. When it is determined that no request packet is received from the client 30 (step S302: NO), on the other hand, the notification processor 212 sends a packet representing “no request” as a reply to the polling from the NAS 10 (step S306). After completion of the processing at either step S304 or step S306, the notification processor 212 returns the processing flow to step S300 and stands by for reception of a polling.

A-7. Processing by Client

The following describes series of processing performed by the client 30.

A-7-1. Server Communication Process on Client

FIG. 8 is a flowchart showing a procedure of server communication process on client. The server communication process on client causes the client 30 to send a “communication start/end request” to the notification server 20 and is performed by the GUI request acquirer 312 and the connection demander 314 as the functional parts of the CPU 310. The server communication process on client includes the “connection request function” in the claims. The GUI request acquirer 312 fulfills the “acquisition function” in the claims.

The connection demander 314 of the client 30 determines whether the GUI request acquirer 312 receives a communication start or a communication end from the graphical user interface (hereinafter referred to as “GUI”) (step S400). More specifically, when the GUI request acquirer 312 receives an input representing start of communication via the GUI, the connection demander 314 determines that a communication start is received. Similarly, when the GUI request acquirer 312 receives an input representing end of communication via the GUI, the connection demander 314 determines that a communication end is received. The GUI function is enabled by cooperation of the display unit 360 with the operation unit 370. When it is determined that either the communication start or the communication end is received (step S400: YES), the connection demander 314 sends a request packet corresponding to the received input to the notification server 20 (step S402) and then returns the processing flow to step S400. When it is determined that neither the communication start nor the communication end is received (step S400: NO), on the other hand, the connection demander 314 repeats the processing of step S400.

A-7-2. NAS Communication Process on Client

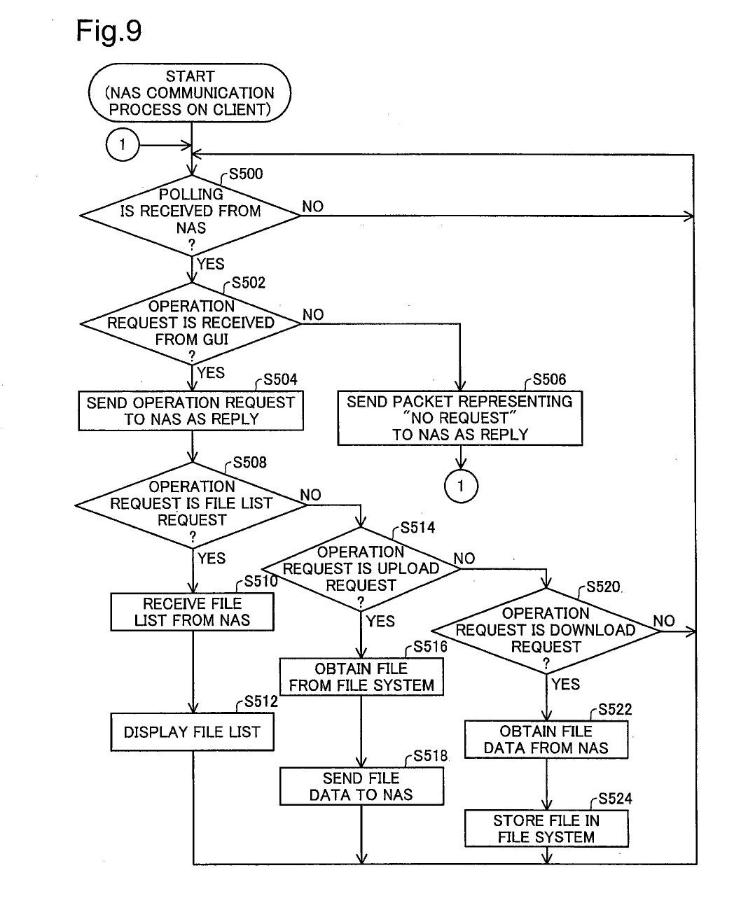

FIG. 9 is a flowchart showing a procedure of NAS communication process on client. The NAS communication process on client causes the client 30 to transfer data to and from the NAS 10 and is performed by the GUI request acquirer 312 and the operation demander 316 as the functional parts of the CPU 310. The NAS communication process on client includes the “operation request function” in the claims.

The operation demander 316 of the client 30 determines whether a polling is received from the NAS 10 (step S500). When it is determined that no polling is received from the NAS 10 (step S500: NO), the operation demander 316 repeats the processing of step S500 and stands by for reception of a polling. When it is determined that the polling is received from the NAS 10 (step S500: YES), on the other hand, the operation demander 316 subsequently determines whether the GUI request acquirer 312 receives an operation request from the GUI (step S502). According to this embodiment, the “operation request” intends a request for file operation/folder operation to the NAS 10. When it is determined that no operation request is received from the GUI (step S502: NO), the operation demander 316 sends a packet representing “no request” as a reply to the polling from the NAS 10 (step S506).

When it is determined that the operation request is received from the GUI (step S502: YES), on the other hand, the operation demander 316 sends an operation request as a reply to the polling from the NAS 10 (step S504). More specifically, the operation demander 316 generates a reply packet including an operation request specified by the GUI input (for example, a “request to obtain a file list”, a “request to upload” or a “request to download”) and information for identifying the target of the operation request specified by the GUI input (for example, a “location on the NAS 10” or a “file (folder) identifier”). The operation demander 316 then sends the generated reply packet.

The operation demander 316 subsequently determines whether the operation request sent at step S504 is a file list request, i.e., “request to obtain a file list” (step S508). When it is determined that the operation request sent at step S504 is the file list request (step S508: YES), the operation demander 316 makes a request to the NAS 10 (FIG. 1) to send a list of files and folders and receives the list of files and folders sent from the NAS 10 (step S510). The processing of the NAS 10 corresponding to the processing of the client 30 at step S510 is the processing of steps S210 to S214 in FIG. 6. The operation demander 316 then causes the display unit 360 to display the received list of files and folders (step S512).

When it is determined that the operation request sent at step S504 is not the file list request (step S508: NO), on the other hand, the operation demander 316 subsequently determines whether the operation request sent at step S504 is an upload request, i.e., “request to upload” (step S514). When it is determined that the operation request sent at step S504 is the upload request (step S514: YES), the operation demander 316 gives an instruction to the file server module 318 to access the data storage 322 in the HDD 320 and obtain a file or a folder specified by the GUI input (step S516). The operation demander 316 then sends the obtained file or folder to the NAS 10 (step S518). The processing of the NAS 10 corresponding to the processing of the client 30 at step S518 is the processing of steps S216 to S220 in FIG. 6.

When it is determined that the operation request sent at step S504 is not the upload request (step S514: NO), on the other hand, the operation demander 316 subsequently determines whether the operation request sent at step S504 is a download request, i.e., “request to download” (step S520). When it is determined that the operation request sent at step S504 is the download request (step S520: YES), the operation demander 316 makes a request to the NAS 10 to send a file or a folder and receives the file or the folder sent from the NAS 10 (step S522). The processing of the NAS 10 corresponding to the processing of the client 30 at step S522 is the processing of steps S222 to S226 in FIG. 6. The operation demander 316 then gives an instruction to the file server module 318 to store the received file or folder in the data storage 322 of the HDD 320 (step S524).

When it is determined that the operation request sent at step S504 is not the download request (step S520: NO), on the other hand, the operation demander 316 returns the processing flow to step S500 and stands by for a polling from the NAS 10. The processing flow is also returned to step S500 after completion of the processing at any one of steps S512, S518 and S524.

The foregoing describes the series of processing performed by the respective devices included in the network storage system 1000, i.e., the NAS 10, the notification server 20 and the client 30. The following describes the general processing flow of the network storage system 1000 as the combination of the above respective processing flows along the time axis.

A-8. Client Standby Sequence

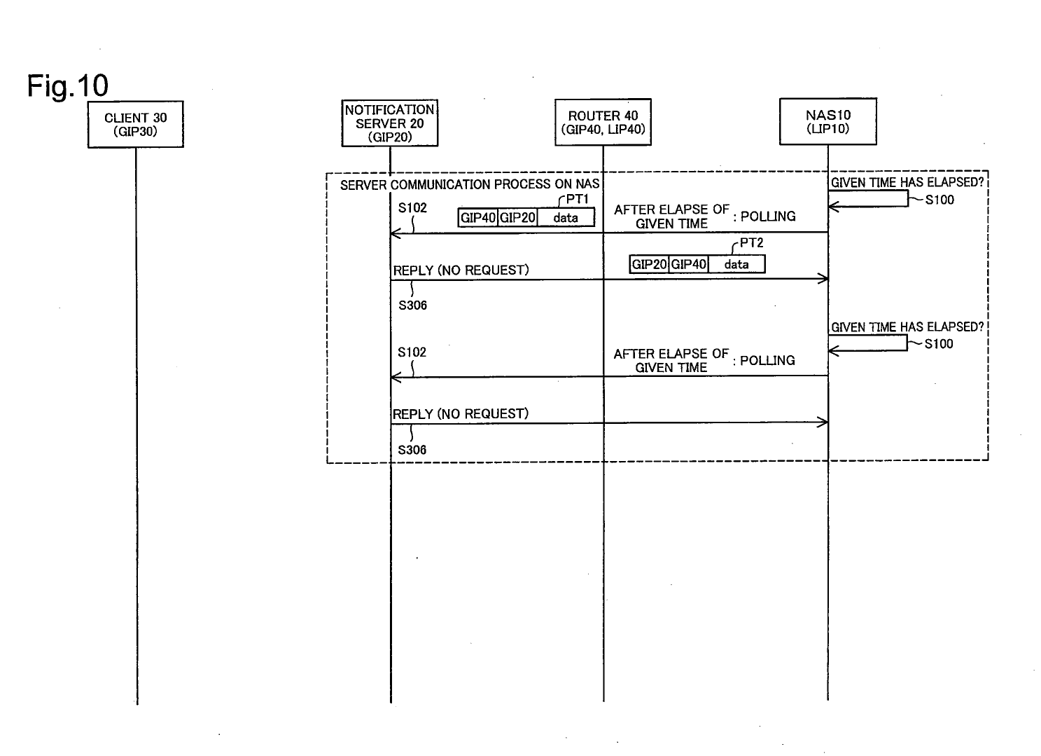

FIG. 10 illustrates a client standby sequence. The client standby sequence causes the NAS 10 (FIG. 1) to stand by for access from the client 30. This client standby sequence is provided as the combination of the server communication process (FIG. 5) performed by the NAS 10 and the notification process (FIG. 7) performed by the notification server 20. The step numbers in FIG. 10 correspond to the step numbers in the flowcharts of FIGS. 5 to 9. The same applies to the subsequent sequence diagrams. With respect to packets sent and received between the respective devices, for convenience of illustration, the source and destination addresses of each packet are explicitly shown only for the initial communication but are not shown for the second or subsequent communications.

As illustrated in FIG. 10, the NAS 10 stands by, while sending a polling packet PT1 to the notification server 20 (FIG. 5: step S102) every after elapse of a given time (FIG. 5: step S100). The packet PT1 has the global IP address of the router 40 as the source address and the global IP address of the notification server 20 as the destination address assigned by the router 40. The notification server 20 receives the packet PT1 and sends a reply packet PT2 representing “no request” as a response to the packet PT1 (FIG. 7: step S306) when there is no request from the client 30. The packet PT2 has the global IP address of the notification server 20 as the source address and the global IP address of the router 40 as the destination address and includes data representing “no request” in the data field. The packet PT2 is a reply packet to the packet PT1 and is thereby forwarded to the NAS 10 by the router 40.

A-9. Communication Start/In-Communication Sequence

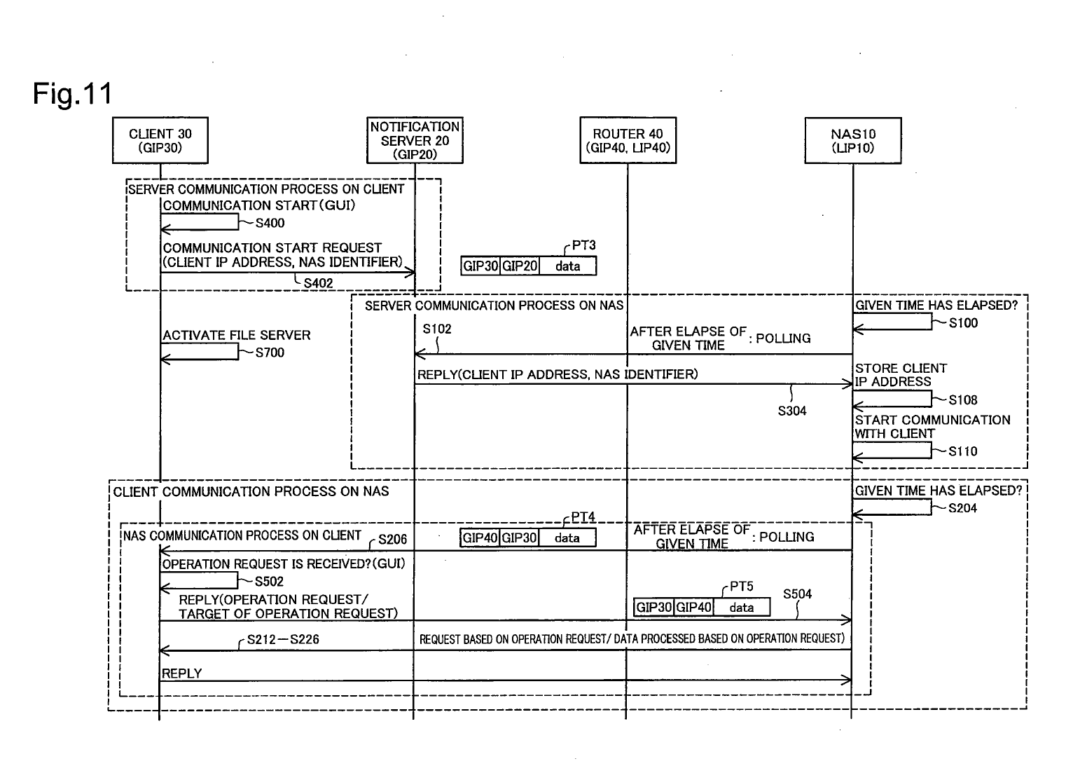

FIG. 11 illustrates a communication start/in-communication sequence. The communication start/in-communication sequence causes the NAS 10 (FIG. 1) and the client 30 to have direct access, in response to an access start request from the client 30. The communication start/in-communication sequence is provided as the combination of all the processing flows described above with reference to FIGS. 5 to 9.

As illustrated in FIG. 11, when an input representing a communication start is received from the GUI (FIG. 8: step S400), the client 30 sends a packet PT3 as a communication start request to the notification server 20 (FIG. 8: step S402). The packet PT3 has the global IP address of the client 30 as the source address and the global IP address of the notification server 20 as the destination address and includes the IP address “GIP30” of the client 30 and an identifier of the NAS 10 (for example, name of the NAS 10) as the target of connection request by the client 30 in the data field. After sending the packet PT3, the client 30 activates its own file server module 318 (step S700).

When receiving the packet PT3 representing a communication start request from the client 30, the notification server 20 sends the request packet PT3 received from the client 30 to the NAS 10 as a reply to the polling (FIG. 5: step S102) that is made at regular intervals by the NAS 10 (FIG. 7: step S304). When receiving the reply packet, the NAS 10 stores the IP address of the client 30 included in the received reply packet (FIG. 5: step S108) and subsequently starts the client communication process (FIG. 6) (FIG. 5: step S110).

The NAS 10 stands by, while sending a polling packet PT4 (FIG. 6: step S206) to the client 30 every after elapse of a given time (FIG. 6: step S204). The packet PT4 has the global IP address of the router 40 as the source address and the global IP address of the client 30 as the destination address assigned by the router 40. When receiving the packet PT4, the client 30 generates and sends a reply packet PT5 including an operation request received from the GUI (FIG. 9: step S502) and information for identifying the target of the operation request (FIG. 9: step S504). The packet PT4 has the global IP address of the client 30 as the source address and the global IP address of the router 40 as the destination address and includes the detail of the operation request and information for identifying the target of the operation request in the data field. The packet PT5 is a reply packet to the packet PT4 and is thereby forwarded to the NAS 10 by the router 40.

When receiving the reply packet PT5 from the client 30 (FIG. 6: step S208), the NAS 10 accesses the data storage 122 of the HDD 120 in response to the operation request included in the received packet PT5 and performs series of processing specified by the operation request included in the received packet PT5 (FIG. 6: steps S212 to S226). For example, it is assumed that the operation request included in the reply packet PT5 is a “file list request” (FIG. 6: step S210: YES). In this case, the NAS 10 accesses the data storage 122 and obtains a list of files and folders (FIG. 6: step S212). The NAS 10 then sends the obtained list of files and folders to the client 30 (FIG. 6: step S214).

The network storage system 1000 may repeat the processing of and after step S204 with the polling made at regular intervals by the operation request acquirer 114 of the NAS 10 (FIG. 6: steps S204 and S206) as the trigger until completion of the client communication process (FIG. 6) by a communication end sequence described below. The address of the polling packet sent by the polling at regular intervals is the global IP address of the client 30 stored in the data storage 122 of the HDD 120. This enables the NAS 10 to continuously receive and process the operation request from the client 30.

When no reply to the polling to the client 30 (FIG. 6: steps S204 and S206) is received within a specified time, that is, when no reply packet is received within the specified time at step S04 in FIG. 9, the operation request acquirer 114 of the NAS 10 may send a polling packet again to the same IP address. The “specified time” may be set to any arbitrary value. When there is no reply to the polling to the address stored in the address storage 124 within the specified time, the operation request acquirer 114 of the NAS 10 makes the polling again to the same address. Even when there is any loss of the polling packet or the reply packet, for example, due to communication failure, retransmission of the polling packet enables continuation of the processing.

A-10. Communication End Sequence

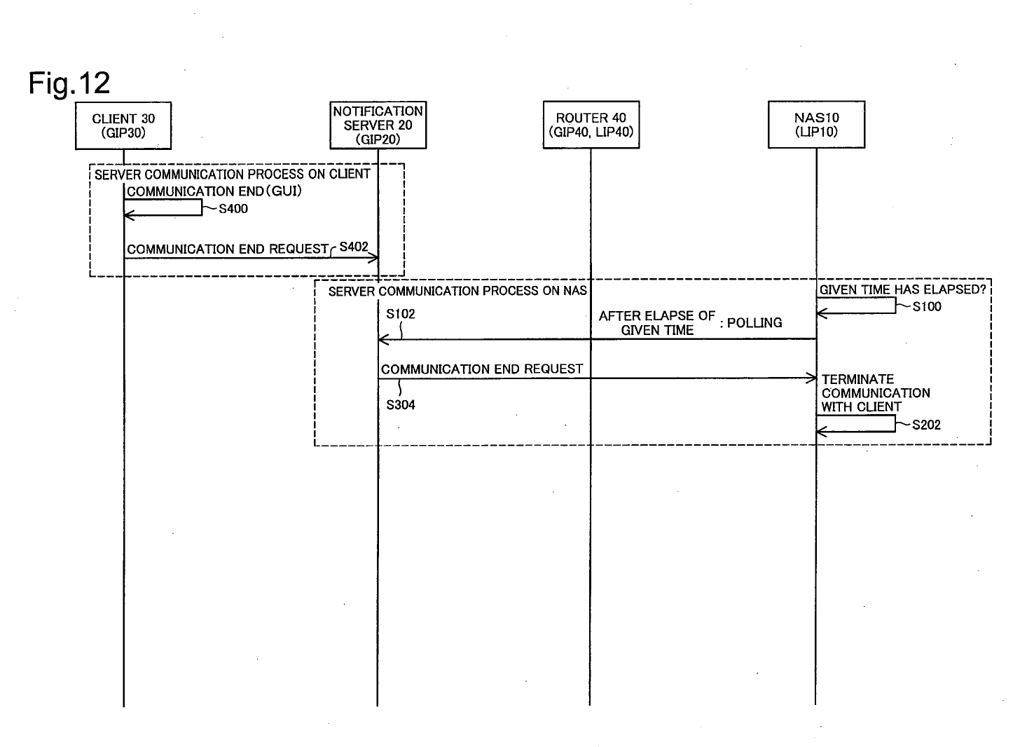

FIG. 12 illustrates a communication end sequence. The communication end sequence terminates access between the NAS 10 and the client 30, in response to an access end request from the client 30. The communication end sequence is provided as the combination of the server communication process (FIG. 8) performed by the client 30, the notification process (FIG. 7) performed by the notification server 20 and the server communication process (FIG. 5) performed by the NAS 10.

As illustrated in FIG. 12, when receiving an input representing a communication end from the GUI (FIG. 8: step S400), the client 30 sends a packet representing a request to terminate communication to the notification server 20 (FIG. 8: step S402). When receiving the packet representing the request to terminate communication from the client 30 (FIG. 7: step S302), the notification server 20 sends the request packet received from the client 30 (FIG. 7: step S304) as a reply packet to the polling made at regular intervals from the NAS 10. The NAS 10 receives the replay packet (FIG. 6: step S202) and terminates the client communication process (FIG. 6).

In the first embodiment described above, the notification processor 212 of the notification server 20 receives both a request to start communication from the client device (client 30) and an inquiry (polling) from the storage device (NAS 10), and sends information representing the presence or the absence of the request to start communication from the client 30 and the address of the client 30 as a reply to the polling from the NAS 10. In other words, the notification server 20 sends the information or the address of the client 30 as a reply to the polling made by the NAS 10. This configuration enables even the notification server 20 that is not notified of the address of the NAS 10 to make communication with the NAS 10, which may be located in a LAN.

The address acquirer 112 of the NAS 10 obtains the address of the client 30 from the notification server 20, and the operation request acquirer 114 makes an inquiry about the operation request for the NAS 10, to the client 30 having the obtained address. In other words, the NAS 10 enables the address of the client 30, which makes a request for connection to the NAS 10, to be obtained from the notification server 20. This intends that the NAS 10 is not required to be notified of the address of the client 30 in the initial state.

The operation demander 316 of the client 30 receives the polling from the NAS 10 and sends an operation request for data to the NAS 10 as a reply to the polling. In other words, the client 30 sends the operation request for data as a reply to the polling made by the NAS 10. This configuration enables even the client 30 that is not notified of the address of the NAS 10 to make communication with the NAS 10, which may be located in a LAN. The request transmitter 116 of the NAS 10 sends the client 30 a further request to continue the processing based on the operation request obtained from the client 30 and the substantial data processed in the NAS 10 based on the operation request obtained from the client 30.

This results in providing the network storage system 1000 that has access to the NAS 10 located in a LAN via the Internet without using the UPnP function of the router 40 or using a relay server provided to relay data forwarding.

### B. Second Embodiment

A second embodiment of the disclosure describes the configuration that uses the “CloudStor” function and causes a relay server to relay data forwarding, in the failure of direct access between the NAS and the client in the sequence of the first embodiment. The like components to those of the first embodiment are expressed by the like symbols to those of the above first embodiment and are not specifically described here.

A network storage system 1000a of the second embodiment includes a relay server 60, in addition to the network storage system 1000 shown in FIG. 1. The relay server 60 works to provide online storage services and relays data forwarding between an NAS 10a and a client 30. The relay server 60 is located on the Internet INET to serve as an external node of the router 40 and has an assigned global IP address “GIP60”.

The NAS 10a of the second embodiment has an operation request acquirer 114a, instead of the operation request acquirer 114 (FIG. 2), as the functional part of the CPU 110. The other configuration of the NAS 10a of the second embodiment is similar to that of the NAS 10 of the first embodiment shown in FIG. 2. The configurations of the notification server 20 and the client 30 of the second embodiment are identical with those of the first embodiment shown in FIGS. 3 and 4.

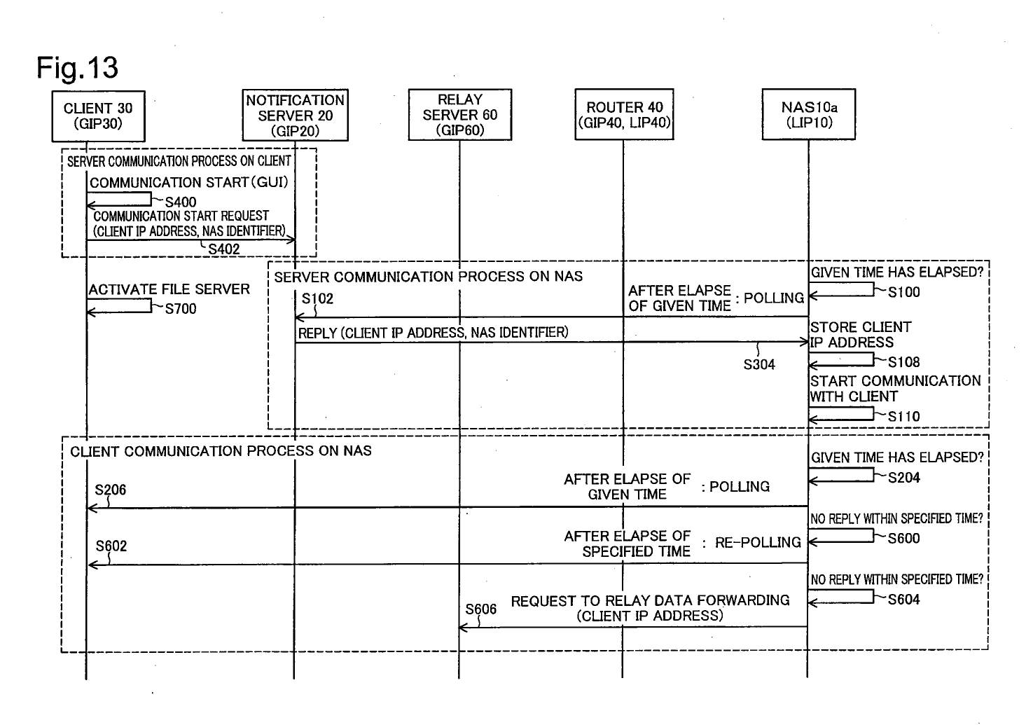

FIG. 13 illustrates a communication start/in-communication sequence of the second embodiment. The communication start/in-communication sequence of the second embodiment includes the processing of steps S600 to S606, in addition to the communication start/in-communication sequence of the first embodiment (FIG. 11). Otherwise the communication start/in-communication sequence of the second embodiment is similar to the communication start/in-communication sequence of the first embodiment. The following describes the sequence in the middle of the client communication process performed by the NAS 10 (step S204).

The operation request acquirer 114a of the NAS 10a stands by, while sending a polling packet to the client 30 (FIG. 6: step S206) every after elapse of a specified time (FIG. 6: step S204). When there is no reply to the polling made at step S206 within the specified time (step S600), the operation request acquirer 114a makes a re-polling to the same address (i.e., client 30) (step S602). More specifically, the operation request acquirer 114a resends the polling packet sent at step S206. The “specified time” at step S600 may be set to any arbitrary value. When there is no reply to the re-polling made at step S602 within a specified time (step S604), the operation request acquirer 114a makes a request to the relay server 60 to relay data forwarding (step S606). The process of relaying data forwarding by the relay server 60 is implemented by, for example, the known function called “CloudStor” and is thus not specifically described here. The “specified time” at step S604 may be set to any arbitrary value. The specified time at step S600 may be set independently of the specified time at step S604.

The foregoing describes the processing flow of the operation request acquirer 114a when there is no reply to the polling made at step S206. When there is a reply to the polling made at step S206, on the other hand, the operation request acquirer 114a follows the same processing flow as that of the first embodiment shown in FIG. 11.

As described above, the second embodiment has the similar advantageous effects to those of the first embodiment. Additionally, when there is no reply to the re-inquiry (re-polling) within the specified time, the operation request acquirer 114 of the storage device (NAS 10) makes a request to the relay server 60, which is provided to relay data forwarding between the NAS 10 and the client 30, to relay the data forwarding. Even when the NAS 10 fails to obtain a reply, this processing flow enables data forwarding between the NAS 10 and the client 30, thus improving the availability of the network storage system 1000a.

### C. Modifications

The disclosure is not limited to the above embodiments but various modifications and variations may be made to the embodiments without departing from the scope of the disclosure. Some examples of possible modifications are given below.

C1. Modification 1

The above embodiments illustrate the exemplary configurations of the network storage system. The configuration of the network storage system is, however, not limited to those of the above embodiments but may be determined arbitrarily within the scope of the disclosure. For example, any of terminals, management devices and other network relay devices may be added to the configuration of FIG. 1. In another example, part of the devices shown in FIG. 1 may be omitted.

According to one modification, when the client is notified of the global IP address of the router connected with the NAS and when the NAS is notified of the global IP address of the client by another method but the method using the notification server, the network storage system may be structured without the notification server.

C2. Modification 2

The structure of the network attached storage (NAS) is described in the above embodiment. The structure of the NAS described in the above embodiment is, however, only illustrative and any other suitable structure may be employed for the NAS. The structure of the NAS may be modified and varied, for example, by omitting part of the components, adding other components or changing part of the components.

According to one modification, the NAS may additionally include other functional parts that are not described in the above embodiment. For example, the NAS may be provided with other interfaces, such as a USB interface, a wireless communication interface and a Bluetooth (registered trademark) interface. Another storage medium, such as flash ROM may be used instead of the HDD.

C3. Modification 3

The structure of the notification server is described in the above embodiment. The structure of the notification server described in the above embodiment is, however, only illustrative and any other suitable structure may be employed for the notification server. The structure of the notification server may be modified and varied, for example, by omitting part of the components, adding other components or changing part of the components.

C4. Modification 4

The smartphone is illustrated as one example of the client having the function of connecting to the Internet in the above embodiment. The client may be, however, any of various devices other than the smartphone, for example, personal computer, car navigation terminal, game machine, or TV terminal.

The structure of the client is described in the above embodiment. The structure of the client described in the above embodiment is, however, only illustrative and any other suitable structure may be employed for the client. The structure of the client may be modified and varied, for example, by omitting part of the components, adding other components or changing part of the components. For example, another storage medium, such as flash ROM may be used instead of the HDD.

C5. Modification 5

Some examples of the operation request that the client receives from the GUI are described in the above embodiment. These operation requests are, however, only illustrative and the client may receive any of various other operation requests from the GUI. Some examples of the operation request may include a “request to delete a file or a folder”, a “request to newly create a file or a folder” and a “request to change the name of a file or a folder”. Other examples of the operation request may include a “request to transfer a folder in a certain folder to another folder in the storage device or to a folder in another device connected via the network” and a “request to duplicate a file or a folder in the storage device or in another device connected via the network”. In response to any of such operation requests, data may be sent and received between the storage device and the client device. For example, file data may be sent and received between the storage device and the client device, in response to any of these operation requests. In another example, request packets may be sent and received to fulfill any of these operation requests. In other words, data sent and received between the storage device and the client device in response to the operation request may be substantial data that the client requires data processing or may be relevant data, such as commands, used to process substantial data.

C6. Modification 6

The above embodiment describes the exemplary flows of the server communication process on NAS (FIG. 5) and the client communication process on NAS (FIG. 6) performed by the NAS, the notification process (FIG. 7) performed by the notification server, and the server communication process on client (FIG. 8) and the NAS communication process on client (FIG. 9) performed by the client. The procedures shown in FIGS. 5 to 9 are only illustrative and may be modified in various ways, for example, by omitting part of the steps, by adding other steps, or by changing the sequence of the steps.

According to one modification, the “Web access” function may be added to the configuration of the first embodiment described above. More specifically, prior to the processing flows described above in the first embodiment, the NAS and the client may try to have direct access by using the UPnP function of the router. When direct access by using the UPnP function of the router is available, the NAS and the client may enable the “Web access” function for data forwarding. When direct access by using the UPnP function of the router is unavailable, on the other hand, the NAS and the client may perform the processing flows described above in the first embodiment. Such modification desirably increases the possible options for data forwarding method between the NAS and the client.

According to another modification, the “Web access” function may be added to the configuration of the second embodiment described above. This modification desirably increases the possible options for data forwarding method between the NAS and the client.

C7. Modification 7

The second embodiment describes the exemplary flow of the client communication process on NAS. The sequence shown in FIG. 13 is, however, only illustrative and may be modified in various ways.

For example, the frequency of re-polling made by the operation request acquirer is only once in the second embodiment. The operation request acquirer may, however, make a re-polling a plurality of times. The frequency of re-polling made by the operation request acquirer and the “specified time” for standby may be set arbitrarily by the user.

In another example, the notification server and the relay server are provided as separate devices according to the second embodiment but may be provided as one integral server. This modification reduces the cost for server introduction and operation.

C8. Modification 8

The disclosure may also be implemented according to any of the following aspects.

According to a first aspect, there is provided a network storage device including a storage device, a notification server and a client device. The storage device is network-attachable. The storage device, the notification server and the client device are interconnected via a network. The client device includes a connection demander that sends a request to the notification server to start communication with the storage device. The client device also includes an operation demander that receives an inquiry from the storage device and sends an operation request of data for the storage device as a reply to the inquiry. The notification server includes a notification processor that receives an inquiry from the storage device and sends information representing absence of the request to start communication as a reply to the inquiry when there is no request to start communication from the client device, while sending an address of the client device as the reply to the inquiry when there is the request to start communication. The storage device includes an address acquirer that sends an inquiry about the address of the client device to the notification server and acquires the address. The storage device also includes an operation request acquirer that sends an inquiry about the operation request for the storage device to the client device having the acquired address and acquires the operation request. The storage device further includes a request transmitter that performs at least one of reception and transmission of data from and to the client device, based on the acquired operation request.

In the network storage system of this aspect, the notification processor of the notification server receives both a request to start communication from the client device and an inquiry from the storage device and sends the information representing no request to start communication from the client device or the address of the client device as a reply to the inquiry from the storage device. In other words, the notification server sends the address of the client device as a reply to the inquiry made by the storage device. This configuration enables even the notification device that is not notified of the address of the storage device to make communication with the storage device, which may be located in a LAN. The address acquirer of the storage device acquires the address of the client device from the notification server, and the operation request acquirer sends an inquiry about the operation request for the storage device to the client device having the acquired address. In other words, the storage device can acquire the address of the client device, which requires access to the storage device, from the notification server. The storage device is thus not required to be notified of the address of the client device in the initial state. The operation demander of the client device receives an inquiry from the storage device and sends an operation request of data for the storage device as a reply to the inquiry. In other words, the client device sends an operation request of data as a reply to the inquiry made by the storage device. This configuration enables even the client device that is not notified of the address of the storage device to make communication with the storage device, which may be located in a LAN. The request transmitter of the storage device performs at least one of transmission and reception of data to and from the client device, based on the operation request acquired from the client device. This results in providing the network storage system that enables access to the storage device located in a LAN via the Internet without using the UPnP function of a router or using a relay server provided to relay data forwarding.

According to a second aspect, there is provided the network storage system described in the first aspect, wherein the request transmitter of the storage device sends at least one of a request based on the acquired operation request and data processed in the storage device based on the acquired operation request, to the client device.

In the network storage system of this aspect, the request transmitter of the storage device sends the client device a further request to continue the processing based on the operation request acquired from the client device and the substantial data processed in the storage device based on the operation request acquired from the client device.

According to a third aspect, there is provided the network storage system described in either one of the first and second aspects, wherein when there is no reply to the inquiry about the operation request to the acquired address within a specified time, the operation request acquirer of the storage device sends a re-inquiry about the operation request to the same address.

In the network storage system of this aspect, when there is no reply to the inquiry about the operation request within the specified time, the operation request acquirer of the storage device sends a re-inquiry about the operation request to the same address. This configuration enables continuation of the processing even when there is a packet loss due to communication failure.

According to a fourth aspect, there is provided the network storage system described in the third aspect, which further includes a relay server that relays data forwarding between the storage device and the client device, wherein when there is no reply to the re-inquiry within a specified time, the operation request acquirer of the storage device sends a request to the relay server to relay data forwarding to and from the acquired address.

In the network storage system of this aspect, when there is no reply to the re-inquiry within the specified time, the operation request acquirer of the storage device sends a request to relay data forwarding to the relay server provided to relay data forwarding between the storage device and the client device. Even when the storage device fails to acquire the reply, this configuration enables data forwarding between the storage device and the client device, thus improving the availability of the system.

According to a fifth aspect, there is provided the network storage system described in any one of the first to the fourth aspects, wherein the operation request acquirer of the storage device sends an inquiry about the operation request to the acquired address at regular intervals.

In the network storage system of this aspect, the operation request acquirer of the storage device sends an inquiry about the operation request to the acquired destination at regular intervals. This enables the storage device to continuously receive and process the operation request from the client device.

The operation request acquirer of the storage device may, however, send an inquiry about the operation request to the acquired address at irregular intervals or only once.

According to a sixth aspect, there is provided the network storage system described in any one of the first to the fifth aspects, the storage device further comprises an address storage that stores the address acquired by the address acquirer, and the operation request acquirer sends an inquiry about the operation request to the client device by using the address stored in the address storage.

In the network storage system of this aspect, the storage device can store the address acquired by the address acquirer. This configuration enables the storage device to send an inquiry about the operation request by using the destination stored in the address storage without acquiring the address externally every time.

The storage device may, however, be provided without the address storage. In this modification, the operation request acquirer may acquire the address of the client device from another component inside the storage device or an external component outside the storage device.

According to a seventh aspect, there is provided the network storage system described in any one of the first to the sixth aspect, wherein the operation request is any of a request to acquire a list, a request to upload, a request to download, a request to newly create a file or a folder and a request to delete a file or a folder.

The network storage system of this aspect clearly defines the operation request for the storage device.

According to another aspect, there is provided a data manipulation method in the network storage system described above. This method includes at least one of the following steps: (a) the client device making a request to the notification server to start communication with the storage device; (b) the storage device making an inquiry about an address of the client device to the notification server; (c) the notification server sending information representing absence of the request to start communication as a reply to the inquiry when there is no request to start communication from the client device, while sending the address of the client device as the reply to the inquiry when there is the request to start communication; (d) the storage device acquiring the sent address of the client device; (e) the storage device making an inquiry about an operation request of data for the storage device to the client device having the acquired address; (f) the client device sending the operation request for the storage device as a reply to the inquiry; (g) the storage device acquiring the sent operation request; and (h) the storage device performing at least one of transmission and reception of data to and from the client device, based on the operation request acquired in the step (g).

The data manipulation method of this aspect has the advantageous effects similar to those of the network storage system of the first aspect.

According to still another aspect, there is provided a storage device having at least one of the following components: an address acquirer that sends an inquiry about an address of a client device connected with the storage device via a network to a notification server connected with the storage device via the network, and acquires the address; an operation request acquirer that sends an inquiry about an operation request of data for the storage device to the client device having the acquired address and acquires the operation request; and a request transmitter that performs at least one of reception and transmission of data from and to the client device, based on the acquired operation request.

This configuration provides the storage device that enables access from the client device via the Internet without using the UPnP function of a router or using a relay server provided to relay data forwarding.

According to yet another aspect, there is provided a computer program product configured to control a client device and have a non-transitory computer readable medium; and a computer program stored in the non-transitory computer readable medium. The computer program includes at least one of the following portions: a portion to send a request to a notification server connected with the client device via a network to start communication with a storage device connected with the client device via the network; a portion to acquire an operation request of data for the storage device; and a portion to receive an inquiry from the storage device and send the operation request acquired by the acquiring portion as a reply to the inquiry.

This configuration provides the computer program product, which may be installed in the client device and used in cooperation with the storage device described above to enable access to the storage device located in a LAN without using the UPnP function of a router or using a relay server provided to relay data forwarding.

What is claimed is:

1. A network storage system including a network-attachable storage device, a notification server and a client device connected via a network,
the client device configured to:
send a request to the notification server to start communication with the storage device;
receive, from the storage device, a second inquiry about an operation request of data for the storage device; and
send the operation request of data for the storage device as a reply to the second inquiry;
the notification server configured to:
receive, from the client device, the notification to start communication with the storage device;
receive, from the storage device, a first inquiry about an address of the client device inquiry;
send, to the storage device, information representing an absence of the request to start communication as a reply to the first inquiry when there is no request to start communication received from the client device; and
send, to the storage device, the address of the client device as the reply to the first inquiry when there is the request to start communication received from the client device; and
the storage device configured to:
send the first inquiry to the notification server, and acquire the address from the notification server as a reply to the first inquiry;
send the second inquiry when the client address is acquired, and acquire the operation request from the client device as a reply to the second inquiry; and
perform at least one of a reception and a transmission of data respectively from or to the client device, based on the acquired operation request.

2. The network storage system according to claim 1, wherein
the storage device is configured to send, to the client device, at least one of a request based on the acquired operation request and data processed in the storage device based on the acquired operation request.

3. The network storage system according to claim 1, wherein
when there is no reply to the second inquiry about the operation request to the acquired address within a first specified time, the storage device is configured to send a re-inquiry about the operation request to the same address.

4. The network storage system according to claim 3, further comprising:
a relay server configured to relay data between the storage device and the client device.

5. The network storage system according to claim 4, wherein
when there is no reply to the re-inquiry within a second specified time, the storage device is configured to send a request to the relay server to relay data to and from the acquired address.

6. The network storage system according to claim 1, wherein
the storage device is configured to send the second inquiry to the acquired address at regular intervals.

7. The network storage system according to claim 1, wherein
the storage device is configured to store the acquired address and send the second inquiry to the client device using the stored address.

8. The network storage system according to claim 1, wherein
the operation request is any one of a request to acquire a list, a request to upload, a request to download, a request to newly create a file or a folder, and a request to delete a file or a folder.

9. A data manipulation method in a network storage system including a network-attachable storage device, a notification server and a client device that are interconnected via a network, the data manipulation method comprising:
requesting, by the client device, the notification server to start communication with the storage device;
inquiring, as a first inquiring by the storage device, about an address of the client device to the notification server;
sending, by the notification server, information representing an absence of the request to start communication as a reply to the first inquiring when there is no request to start communication from the client device, and sending the address of the client device as the reply to the first inquiring when there is the request to start communication;
acquiring, by the storage device, the sent address of the client device;
inquiring, as a second inquiring by the storage device, about an operation request of data for the storage device to the client device having the acquired address;
sending, by the client device, the operation request for the storage device as a reply to the second inquiring;
acquiring, by the storage device, the sent operation request; and
performing, by the storage device, at least one of transmission and reception of data respectively to or from the client device, based on the sent operation request acquired by the storage device.

10. The data manipulation method according to claim 9, further comprising:
sending, by the storage device to the client device, at least one of a request based on the acquired operation request and data processed in the storage device based on the acquired operation request.

11. The data manipulation method according to claim 9, further comprising:
making, by the storage device, a re-inquiry about the operation request to the acquired address when there is no reply to the inquiry in the second inquiring within a first specified time.

12. The data manipulation method according to claim 11, further comprising:
requesting, by the storage device, a relay server, which is provided to relay data between the storage device and the client device, to relay data to and from the acquired address when there is no reply to the second inquiring within a second specified time.

13. The data manipulation method according to claim 9, wherein
the second inquiring occurs at regular intervals.

14. The data manipulation method according to claim 9, further comprising:
storing, in an address storage, the address acquired in response to the first inquiring, wherein
the second inquiring includes sending an inquiry about the operation request to the client device by using the stored address.

15. The data manipulation method according to claim 9, wherein
the operation request is any of a request to acquire a list, a request to upload, a request to download, a request to newly create a file or a folder, and a request to delete a file or a folder.

16. A storage device, comprising:
an address acquirer that sends a first inquiry about an address of a client device connected with the storage device via a network to a notification server connected with the storage device via the network, and acquires the address as a reply to the first inquiry;
an operation request acquirer that sends a second inquiry about an operation request of data for the storage device to the client device having the acquired address, and acquires the operation request as a reply to the second inquiry; and
a request transmitter that performs at least one of a reception and a transmission of data respectively from or to the client device, based on the acquired operation request.

17. A non-transitory computer readable medium having instructions stored therein that, when executed by a processor, causes a computer to perform a method comprising:
requesting, by a client device, a notification server to start communication with a storage device;
inquiring, as a first inquiring by the storage device, about an address of the client device to the notification server;
sending, by the notification server, information representing an absence of the request to start communication as a reply to the first inquiring when there is no request to start communication from the client device, and sending the address of the client device as the reply to the first inquiring when there is the request to start communication;
acquiring, by the storage device, the sent address of the client device;
inquiring, as a second inquiring by the storage device, about an operation request of data for the storage device to the client device having the acquired address;
sending, by the client device, the operation request for the storage device as a reply to the second inquiring;
acquiring, by the storage device, the sent operation request; and
performing, by the storage device, at least one of transmission or reception of data respectively to or from the client device, based on the sent operation request acquired by the storage device.
